(19) United States
(12) Patent Application Publication
(10) Pub. No.: US 2025/0321460 A1
(43) Pub. Date: Oct. 16, 2025

(54) OPTICAL SHORT PULSE GENERATOR, OPTICAL SHORT PULSE GENERATION METHOD, AND PROGRAM

(71) Applicant: Nippon Telegraph and Telephone Corporation, Tokyo (JP)

(72) Inventors: Atsushi TANIGUCHI, Musashino-shi, Tokyo (JP); Hideki NISHIZAWA, Musashino-shi, Tokyo (JP); Kazuaki OBANA, Musashino-shi, Tokyo (JP); Yasuyuki SANARI, Musashino-shi, Tokyo (JP)

(21) Appl. No.: 18/865,988

(22) PCT Filed: May 31, 2022
(86) PCT No.: PCT/JP2022/022147

§ 371 Date: Nov. 14, 2024

(51) Int. Cl. G02F 1/21

(52) U.S. Cl. CPC G02F 1/212; G02F 2201/20; G02F 2203/26

(57) ABSTRACT

It includes a first optical intensity modulator (2) that outputs an optical pulse in which the signal intensity of photocarriers output from a light source (1) is modulated in accordance with the magnitude of a first drive signal around an operation bias point α, a delay unit (3) that generates a second drive signal obtained by delaying the first drive signal by a half cycle, and a second optical intensity modulator (4) that outputs an optical short pulse in which the signal intensity of the optical pulse is modulated in accordance with the magnitude of the second drive signal around an operation bias point.

### TECHNICAL FIELD

The present invention relates to an optical short pulse generator, an optical short pulse generation method, and a program for generating an optical pulse having a high repetition rate and a short pulse width (optical short pulse).

### BACKGROUND ART

In an optical communication system, when a signal is transmitted by an optical pulse intensity modulation method, it is effective to shorten the pulse width of an optical pulse to be transmitted to suppress spreading of the pulse due to dispersion of the fiber.

There are two main methods for generating optical pulses: the direct modulation method of directly modulating an electric signal to light and an external modulation method of modulating an optical signal by external modulation.

In the direct modulation method, a high-speed signal is directly modulated, and therefore there is a problem that phase fluctuation (phase chirp) due to wavelength fluctuation occurs. On the other hand, as an external modulation method using an electro-optical effect, there are an electro-absorption type optical intensity modulator and a Mach-Zehnder type optical intensity modulator (hereinafter referred to as the MZ type). Among the MZ types, the push-pull type intensity modulation in which driving is performed by applying a voltage signal having an opposite phase to a phase modulation unit of a waveguide is suitable for high-speed communication because frequency chirp can be suppressed.

As an optical pulse generator using an MZ type optical intensity modulator, a method is known in which an operation bias point of an optical intensity modulator is set so that transmittance of the optical intensity modulator is maximized, and a sinusoidal wave or a rectangular wave drive signal having an amplitude of 2Vπ (Vπ is a half wavelength voltage indicating drive amplitudes corresponding to adjacent maximum transmittance and minimum transmittance) corresponding to one cycle of the light transmission characteristic of the optical intensity modulator is applied, thereby generating a optical pulse having an arbitrary pulse width with less chirp (Patent Literature 1).

In addition, Non Patent Literature 1 discloses a pulse generation method for compensating chirp by phase modulation.

### CITATION LIST

### Patent Literature

Patent Literature 1: JP 2000-89176 A

### Non Patent Literature

Non Patent Literature 1: C. E. Rogers III, “Characterization and compensation of the residual chirp in a Mach-Zehnder-type electro-optical intensity modulator” Optics Express Vol. 18, Issue 2, pp. 1166-1176 (2010)

### SUMMARY OF INVENTION

### Technical Problem

As in the method of Patent Literature 1, a case is considered in which modulation is performed with a rectangular wave of a twofold half wavelength voltage (2Vπ) with a bias point matching the peak of the intensity modulation characteristic to generate a pulse. In this case, since the rectangular wave has a high-frequency component, a generated pulse interval or pulse width are inconsistent because an electric waveform is blunted by an electric device, a cable, or the like. In addition, in an ideal push-pull intensity modulator, the amounts of phase change are equal, and the signs thereof are opposite, so that the phase change is canceled out and modulation without chirp is possible.

However, in an actual push-pull intensity modulator, a slight residual chirp occurs due to variations in branching ratio of a coupler and phase modulation amounts of both.

When a pulse is generated by an intensity modulator having a residual chirp as described above, the chirp of the optical pulse generated at the fall of an electric rectangular wave may be larger in the optical pulse generated at the rise of a drive signal than in the optical pulse generated at the rise of the electric rectangular wave. In addition, there is also a case of the opposite. That is, there is a problem that the chirp and the phase modulation amount are different for each optical pulse.

Note that, in the method of Non Patent Literature 1, when the phase amount is different for each optical pulse, the chirp cannot be compensated.

The present invention has been made in view of this problem, and an object is to provide an optical short pulse generator, an optical short pulse generation method, and a program for generating optical short pulses with minimal variations in pulse width, chirp, and phase modulation amount.

### Solution to Problem

A gist of an optical short pulse generator according to an aspect of the present invention is to include: a first optical intensity modulator that outputs an optical pulse in which a signal intensity of photocarriers output from a light source is modulated in accordance with a magnitude of a first drive signal around an operation bias point; a delay unit that generates a second drive signal obtained by delaying the first drive signal by a half cycle; and a second optical intensity modulator that outputs an optical short pulse in which a signal intensity of the optical pulse is modulated in accordance with a magnitude of the second drive signal around an operation bias point.

In addition, a gist of an optical short pulse generation method according to an aspect of the present invention is to perform a first optical intensity modulation step of outputting an optical pulse in which a signal intensity of photocarriers output from a light source is modulated in accordance with a magnitude of a first drive signal around an operation bias point, a delay step of generating a second drive signal obtained by delaying the first drive signal by a half cycle, and a second optical intensity modulation step of outputting an optical short pulse in which a signal intensity of the optical pulse is modulated in accordance with a magnitude of the second drive signal around an operation bias point.

In addition, a gist of a program according to an aspect of the present invention is an optical short pulse generation program for causing a computer to function as the optical short pulse generator described above.

### Advantageous Effects of Invention

According to the present invention, it is possible to provide an optical short pulse generator, an optical short pulse generation method, and a program capable of generating optical short pulses with minimal variations in pulse width, chirp, and phase modulation amount.

### BRIEF DESCRIPTION OF DRAWINGS

FIG. 1 is a block diagram illustrating a configuration example of an optical short pulse generator according to a first embodiment of the present invention.

FIG. 2 is a schematic diagram for describing an operation of the optical short pulse generator illustrated in FIG. 1.

FIG. 3 is a block diagram illustrating a configuration example of an optical short pulse generator according to a second embodiment of the present invention.

FIG. 4 is a block diagram illustrating a configuration example of an optical short pulse generator according to a third embodiment of the present invention.

FIG. 5 is a flowchart indicating an operation procedure of the optical short pulse generator illustrated in FIG. 4.

FIG. 6 is a block diagram illustrating a configuration example of an optical short pulse generator according to a fourth embodiment of the present invention.

FIG. 7 is a flowchart indicating an operation procedure of the optical short pulse generator illustrated in FIG. 6.

FIG. 8 is a block diagram illustrating a configuration example of an optical short pulse generator according to a fifth embodiment of the present invention.

FIG. 9 is a flowchart indicating an operation procedure of the optical short pulse generator illustrated in FIG. 8.

FIG. 10 is a diagram schematically illustrating a difference between optical pulses depending on the magnitude of extinction ratio.

FIG. 11 is a block diagram illustrating a configuration example of a general-purpose computer system.

### DESCRIPTION OF EMBODIMENTS

Hereinafter, embodiments of the present invention will be described using the drawings. The same reference numerals are given to the same components in the plurality of drawings, and the description thereof will not be repeated.

### First Embodiment

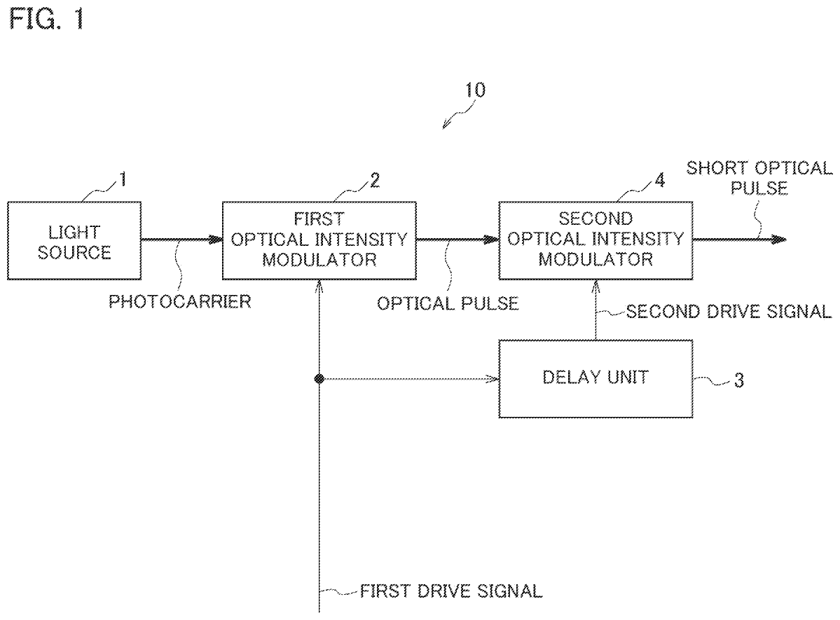

FIG. 1 is a block diagram illustrating a configuration example of an optical short pulse generator according to a first embodiment of the present invention. An optical short pulse generator 10 illustrated in FIG. 1 is an optical short pulse generator 10 that generates an optical short pulse having a short pulse width used for optical communication, light measurement, and the like. Specific examples of the optical short pulse will be described later.

The optical short pulse generator 10 includes a light source 1, a first optical intensity modulator 2, a delay unit 3, and a second optical intensity modulator 4. In FIG. 1, the thick lines indicate the paths of an optical signal, and the thin lines indicate the paths of an electric signal.

The light source 1 outputs photocarriers. The light source 1 is comprised of, for example, a semiconductor laser. Photocarriers are signals that are a source of an optical pulse, and a maximum value of the photocarriers forms a peak value of the optical pulse. Note that the light source 1 may be omitted. It is not necessary when photocarriers are supplied from the outside.

The first optical intensity modulator 2 outputs an optical pulse in which the signal intensity of the photocarriers output from the light source 1 is modulated in accordance with the magnitude of a first drive signal around an operation bias point. As the first optical intensity modulator 2, a push-pull type MZ type optical intensity modulator or a directional coupler type optical intensity modulator can be used.

The MZ type optical intensity modulator is configured to apply a phase difference according to the drive signal to light branched into two light waveguides by a Y-branch waveguide (not illustrated) on the input side, and modulate the output optical intensity by using an interference effect at the time of combination by a Y-branch waveguide on the output side.

Note that the first and second optical intensity modulators 2 and 4 may have a function of adjusting the optical intensity after branching into the two waveguides, and may correct the variation in the branching ratio of the optical intensity on the basis of the waveform after the combination. In addition, the first and second optical intensity modulators 2 and 4 are push-pull type MZ type intensity modulators, and a plurality of MZ type intensity modulators may be mounted on one casing. The operation of modulating the output optical intensity will be described later.

The delay unit 3 generates a second drive signal obtained by delaying the first drive signal by a half cycle. As the delay unit 3, various general phase shifters can be used.

The second optical intensity modulator 4 outputs an optical short pulse in which the signal intensity of the optical pulse output from the first optical intensity modulator 2 is modulated in accordance with the magnitude of the second drive signal around an operation bias point. The second optical intensity modulator 4 is the same as the first optical intensity modulator 2.

### Effect of Optical short pulse Generator

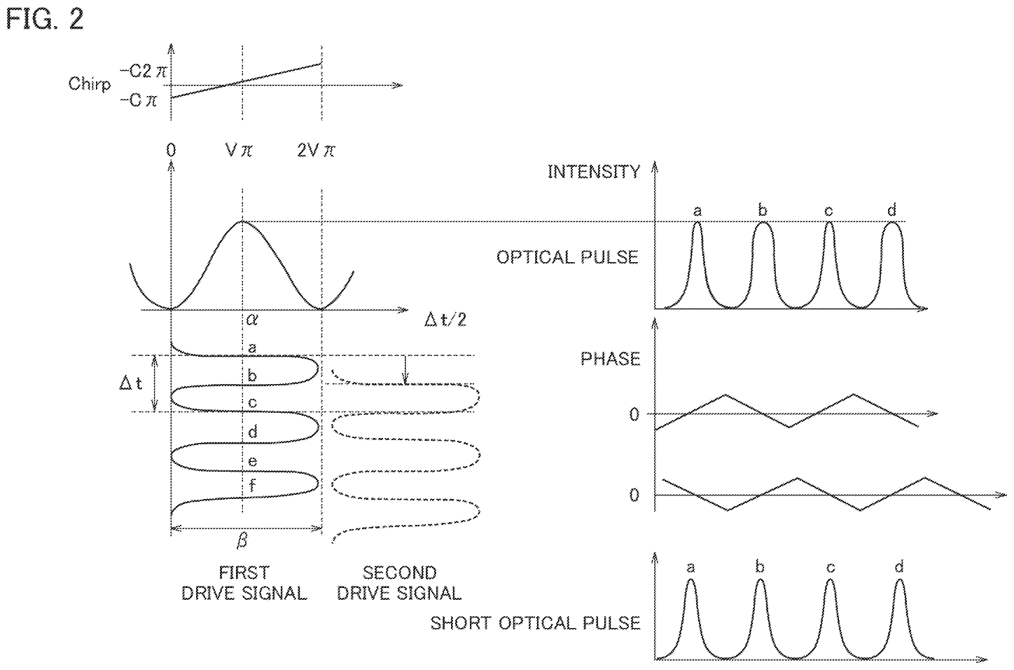

FIG. 2 is a schematic diagram for describing an operation of the optical short pulse generator 10.

In FIG. 2, a horizontal sinusoidal wave in the middle on the left side indicates a change in light transmittance of the first and second optical intensity modulators 2 and 4. A waveform on the left side in the vertical direction (solid line) indicates a change in the first drive signal applied to the first optical intensity modulator 2, and the right direction is defined as positive and the left direction is defined as negative. In addition, the upper left diagram indicates a phase chirp. The horizontal direction is voltage, and the vertical direction is phase change amount.

As illustrated in FIG. 2, an intermediate potential α of the first drive signal is caused to match the maximum value of the light transmittance, and an amplitude β of the first drive signal is caused to match one cycle of the light transmission characteristic. The intermediate potential α of the first drive signal is hereinafter referred to as an operation bias point α.

The first drive signal is a signal of a frequency f having an amplitude of 2Vπ (Vπ is a half wavelength voltage indicating drive amplitudes corresponding to adjacent maximum transmittance and minimum transmittance) corresponding to one cycle of the transmission characteristic of the first optical intensity modulator 2.

A point a of the first drive signal at which the amplitude of the first drive signal matches the operation bias point α corresponds to a of the optical pulse. Thereafter, similarly, points b, c, d . . . of the drive signal respectively correspond to b, c, and d of the optical pulse.

Note that, in this example, the phase change amount when the first drive signal changes from 0 to Vπ is indicated by Cπ, and the phase change amount when the first drive signal changes from Vπ to 2Vπ is indicated by C2π. Even when the same (model) is used for the first optical intensity modulator 2 and the second optical intensity modulator 4, the phase change amounts in the two light waveguides, for example, the Y-branch waveguides, may be different due to manufacturing variations or the like.

In the case of the phase change amount (upper left diagram) illustrated in FIG. 2, the phase delay of the rise of the optical pulse a is small, and the phase delay of the fall of the optical pulse a is large. In FIG. 2, the optical pulse a (the phase delay of the rise is small and the phase delay of the fall is large) is represented by an optical pulse having a short pulse width.

Next, the voltage at the point b of the first drive signal changes from 2Vπ to 0. Therefore, the phase delay of the rise of the optical pulse b increases, and the phase delay of the fall of the optical pulse b decreases. The optical pulse b (the phase delay of the rise is large and the phase delay of the fall is small) is represented by an optical pulse having a wide pulse width.

As described above, the pulse width of the optical pulse output from the first optical intensity modulator 2 is not uniform. In the case of this example, the optical pulse a and the optical pulse b are alternately (a=c, b=d) repeatedly output.

Therefore, in the present embodiment, the second drive signal for changing the light transmittance of the second optical intensity modulator 4 is a signal obtained by delaying the first drive signal by a half cycle. As indicated by the broken line on the right side in the vertical direction in FIG. 2, the second drive signal is a signal obtained by delaying the first drive signal by a half cycle Δt/2.

The second optical intensity modulator 4 modulates the signal intensity of the optical pulse output from the first optical intensity modulator 2 with the second drive signal. As a result, the optical pulse b is affected by the phase change amount Cπ at its rising, and is affected by the phase change amount C2π at its falling. That is, each of the optical short pulses a, b, c, and d is affected by the same phase change by the configuration of the present embodiment.

Accordingly, with the optical short pulse generator 10, since each of the optical pulses is affected by the same phase change, it is possible to generate uniform optical short pulses as illustrated in FIG. 2. Each of the optical short pulses a to d is, for example, a light output pulse having a pulse width of about ⅓ of the cycle of the first and second drive signals.

As described above, the optical short pulse generator 10 according to the present embodiment includes the first optical intensity modulator 2 that outputs an optical pulse in which the signal intensity of photocarriers output from the light source 1 is modulated in accordance with the magnitude of the first drive signal around the operation bias point α, the delay unit 3 that generates the second drive signal obtained by delaying the first drive signal by a half cycle, and the second optical intensity modulator 4 that outputs the optical short pulse in which the signal intensity of the optical pulse is modulated in accordance with the magnitude of the second drive signal around the operation bias point α. As a result, it is possible to generate an optical short pulse having a constant pulse width, chirp, and phase modulation amount.

Note that the first optical intensity modulator 2 and the second optical intensity modulator 4 need to have similar residual chirp characteristics. As a preferable example, the configuration of using the same has been described, but the same one may not be used. For example, the products (models and the like) of the first optical intensity modulator 2 and the second optical intensity modulator 4 may be different. Even when the models and the like are different, as long as the chirp characteristics of the modulators are similar, each of the optical short pulses is affected by the same amount of phase change, so that uniform optical short pulses can be generated. Note that although the first drive signal and the second drive signal have been described as examples of waveforms in which both the upper limit and the lower limit of the waveform are blunted, the first drive signal and the second drive signal may be rectangular waves. In addition, the first drive signal and the second drive signal may be sinusoidal waves or sawtooth waves.

In addition, although the configuration in which two intensity modulators are used is indicated, three or more intensity modulators may be connected in series. In a case where there are two intensity modulators, the chirp characteristics of the intensity modulators need to be similar, but in a case where there are three or more intensity modulators, the amounts of residual chirps are averaged, and thus the variation in chirp is finally reduced. In this case, the delay unit 3 adjusts the driving voltage to be opposite in phase to the rise (or fall) of an electric pulse with deteriorated pulse characteristics, that is, to be fall (or be rise).

### Second Embodiment

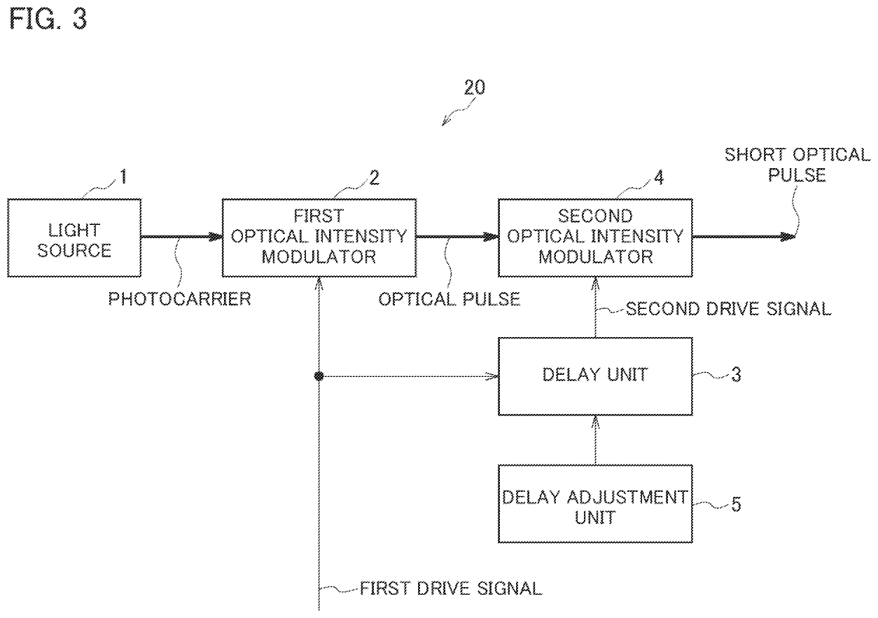

FIG. 3 is a block diagram illustrating a configuration example of an optical short pulse generator according to a second embodiment of the present invention. An optical short pulse generator 20 illustrated in FIG. 3 is different from the optical short pulse generator 10 in that a delay adjustment unit 5 is provided.

The delay adjustment unit 5 increases or decreases a delay amount by which the delay unit 3 delays the first drive signal. The delay amount is externally input to the delay adjustment unit 5. Therefore, with the optical short pulse generator 10, the delay amount of the second drive signal in which the delay amount with respect to the first drive signal is fixed can be adjusted forward and backward (lead and lag).

For example, the delay adjustment unit 5 may prepare a plurality of waveguides (not illustrated) having different line lengths, and adjust the delay amount (phase amount) by selecting each waveguide with a switch (not illustrated). In addition, the delay adjustment unit 5 may use an electric buffer memory or may be configured using various general phase shifters.

As described above, the optical short pulse generator 20 includes the delay adjustment unit 5 that increases or decreases the delay amount by which the delay unit 3 delays the first drive signal. As a result, the optical short pulse can be optimized. Specifically, both the pulse width and the cycle of the optical short pulse are adjusted to be uniform. Note that adjustment may be performed such that either the pulse width or the cycle of the optical short pulse becomes uniform.

### Third Embodiment

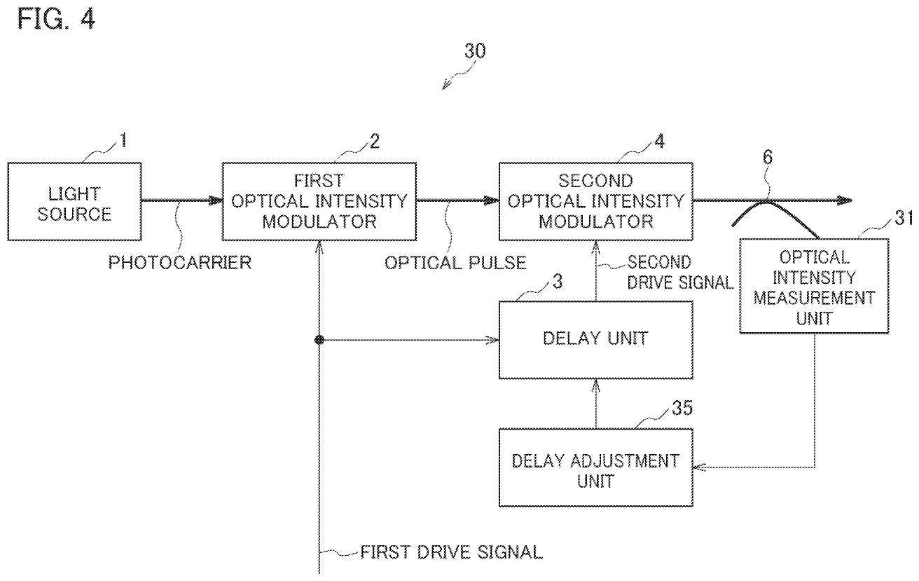

FIG. 4 is a block diagram illustrating a configuration example of an optical short pulse generator according to a third embodiment of the present invention. An optical short pulse generator 30 illustrated in FIG. 4 is different from the optical short pulse generator 20 in that an optical coupler 6, an optical intensity measurement unit 31, and a delay adjustment unit 35 are provided.

The optical coupler 6 branches part of the optical short pulse output from the second optical intensity modulator 4. The optical coupler 6 is a general optical coupler.

The optical intensity measurement unit 31 converts the optical short pulse branched by the optical coupler 6 into an electric signal. The optical intensity measurement unit 31 is a photoelectric element such as a photodiode and a phototransistor. The optical intensity measurement unit 31 measures a time waveform of the optical short pulse.

The delay adjustment unit 35 adjusts the delay amount of the delay unit 3 so that the pulse width of the optical short pulse becomes constant. That is, the delay adjustment unit 35 controls the delay amount of the delay unit 3 so that the time waveform of the optical short pulse fed back by the optical coupler 6 and the optical intensity measurement unit 31 becomes constant.

As a result, the pulse width of the optical short pulse is automatically adjusted by the feedback control.

### Optical short pulse Generation Method

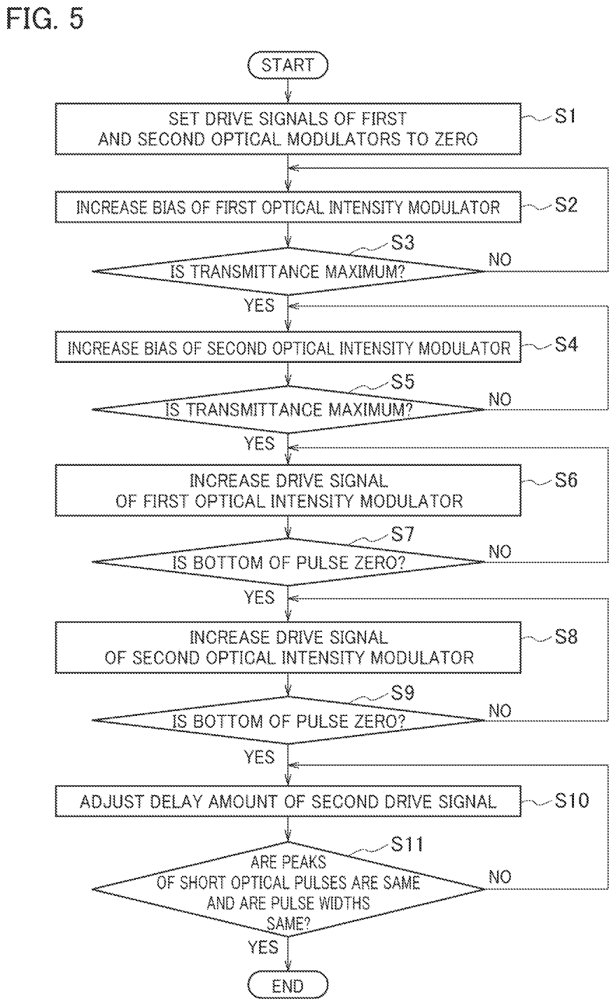

FIG. 5 is a flowchart indicating an operation procedure of the optical short pulse generator 30 (FIG. 4). The subject executing each step of this flowchart is a control unit (not illustrated) and the delay adjustment unit 35.

When the process of adjusting the optical pulse is started, the control unit first sets the amplitudes of the first drive signal and the second drive signal for driving the first and second optical intensity modulators 2 and 4 to zero (step S1).

Next, the control unit increases a bias voltage of the first drive signal so that the signal intensity of the optical signal output from the first optical intensity modulator 2 becomes maximum (until the transmittance becomes maximum (Yes in step S3)) (step S2).

Next, the control unit increases a bias voltage of the second drive signal so that the signal intensity of the optical signal output from the second optical intensity modulator 4 becomes maximum (until the transmittance becomes maximum (Yes in step S5)) (step S4).

Next, the control unit increases the amplitude of the drive signal for driving the first optical intensity modulator 2 so that the signal level between the optical pulses becomes zero (Yes in step S7) (step S6).

Next, the control unit increases the amplitude of the drive signal for driving the second optical intensity modulator 4 so that the signal level between the optical short pulses becomes zero (Yes in step S9) (step S8).

Next, the delay adjustment unit 35 adjusts the delay amount of the second drive signal so that the amplitudes of the respective optical short pulses are the same and the pulse widths are the same (Yes in step S11) (step S10).

In this manner, the optical short pulse generator 30 automatically adjusts the amplitudes of the optical short pulses to be the same and the pulse widths to be the same. Note that either the amplitudes of the optical short pulses or the pulse widths may be preferentially adjusted.

Note that the order of the bias control (steps S2 and S3) of the first optical intensity modulator 2, the bias control (steps S4 and S5) of the second optical intensity modulator 4, the drive signal control (steps S6 and S7) of the first optical intensity modulator 2, and the bias control (steps S8 and S9) of the second optical intensity modulator 4 is not limited. In addition, they may be performed in parallel. When the bottom of the pulse is zero (steps S7 and S9), the time waveform may be observed, or the intensity of the bottom of the pulse may be extracted by a switch. In addition, a component in which the bottom of the pulse is zero may be taken using an interferometer having a cycle of half the pulse interval.

### Fourth Embodiment

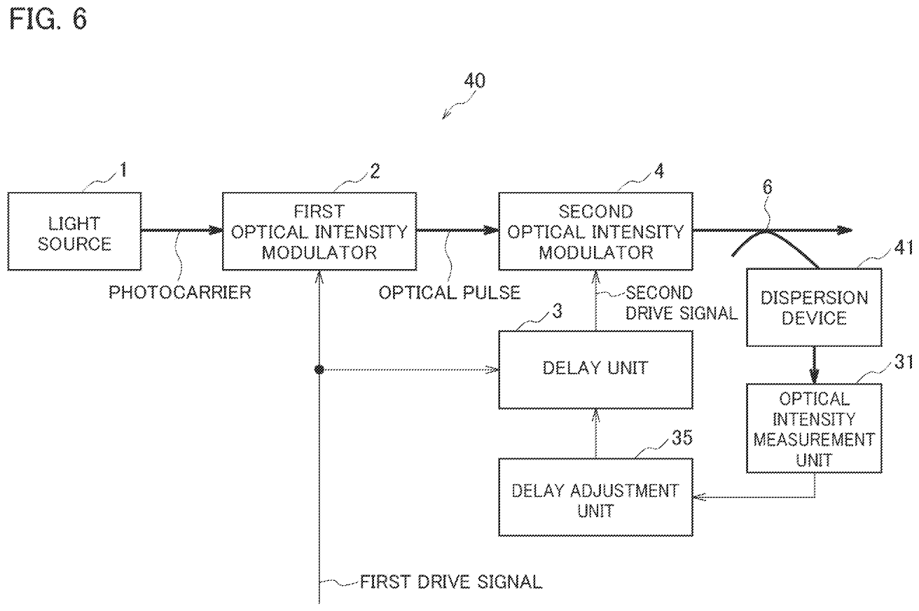

FIG. 6 is a block diagram illustrating a configuration example of an optical short pulse generator according to a fourth embodiment of the present invention. An optical short pulse generator 40 illustrated in FIG. 6 is different from the optical short pulse generator 30 (FIG. 4) in that a dispersion device 41 that disperses light is provided between an optical coupler 6 and an optical intensity measurement unit 31.

The dispersion device 41 is, for example, a dispersion device such as an optical fiber, a diffraction grating, or a Fiber Bragg Grating obtained by modulating the refractive index in a fiber.

In this manner, the optical short pulse generator 40 controls the pulse width of the optical short pulse after the dispersion device 41 to be constant. Accordingly, the effect of the optical fiber between the optical short pulse generator 40 and a reception apparatus can be canceled.

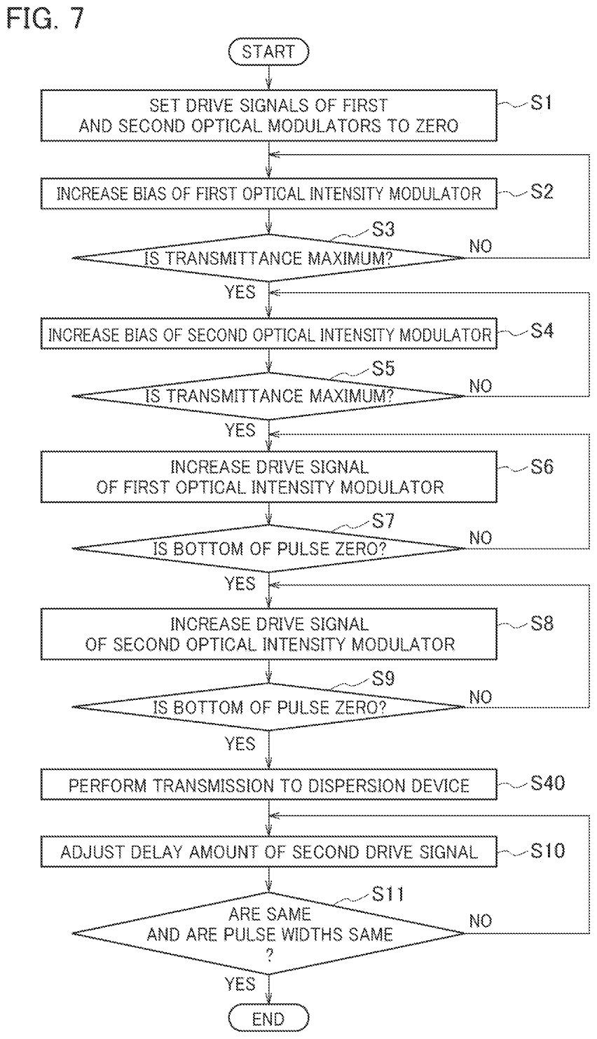

FIG. 7 is a flowchart indicating an operation procedure of the optical short pulse generator 40 (FIG. 6). The operation procedure of the optical short pulse generator 40 is different only in that step S40 of transmitting the optical short pulse to the dispersion device 41 is included. Therefore, a detailed description of FIG. 7 is omitted.

### Fifth Embodiment

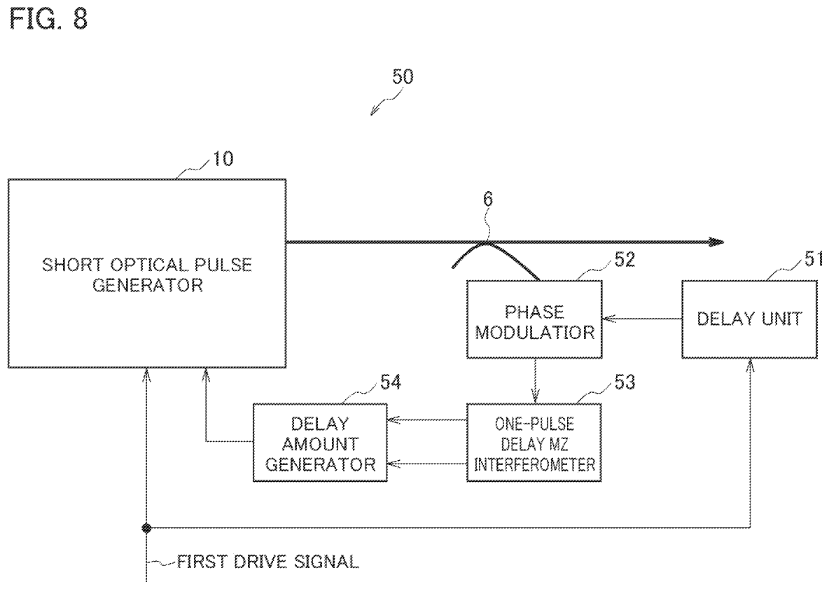

FIG. 8 is a block diagram illustrating a configuration example of an optical short pulse generator according to a fifth embodiment of the present invention. An optical short pulse generator 50 illustrated in FIG. 8 is different from the optical short pulse generator 10 in that an optical coupler 6, a delay unit 51, a phase modulation unit 52, one-pulse delay MZ interferometer 53, and a delay amount generation unit 54 are provided. The optical coupler 6 is the same as those of the optical short pulse generators 30 and 40 as apparent from the reference numeral.

The delay unit 51 delays the first drive signal by Δt.

The phase modulation unit 52 performs phase modulation so that the phase of the optical short pulse becomes a repetition of 0 and π for each pulse.

The one-pulse delay MZ interferometer 53 is an MZ interferometer that combines with a waveguide delayed by one pulse after two branching into two. Delaying may be performed for one or more pulses. The interference amount of the optical short pulse phase-modulated by the phase modulation unit 52 is measured.

The delay amount generation unit 54 generates a delay amount of the second drive signal with respect to the first drive signal on the basis of an electric signal obtained by converting the optical output of the one-pulse delay MZ interferometer 53 into an electric signal. The delay unit 3 (FIG. 1) delays the first drive signal by the delay amount generated by the delay amount generation unit 54.

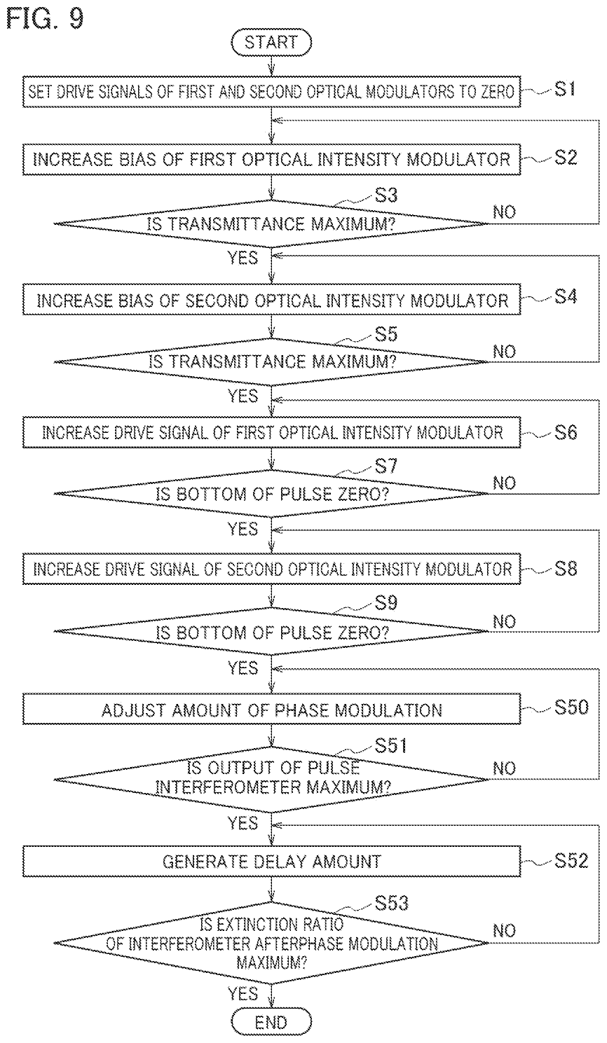

FIG. 9 is a flowchart indicating an operation procedure of the optical short pulse generator 50 (FIG. 8). The operation procedure of the optical short pulse generator 50 is different only in that steps S10 to S11 of the operation procedure of the optical short pulse generator 30 are replaced with steps S50 to S53.

The operation steps of the different points will be described with reference to FIG. 9.

The phase modulation unit 52 adjusts the amount of phase modulation (step S50) so that the output of the one-pulse delay MZ interferometer 53 becomes maximum (Yes in step S51).

The delay amount generation unit 54 generates a delay amount (step S52) so that the extinction ratio of the one-pulse delay MZ interferometer 53 becomes maximum (Yes in step S53).

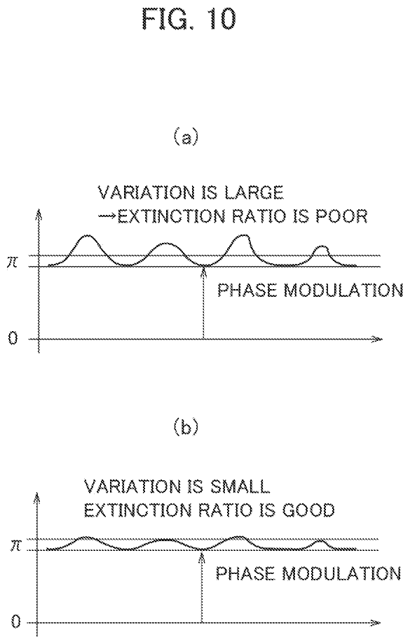

FIG. 10(a) schematically illustrates variations in phase modulation amount in a case where the extinction ratio is poor. FIG. 10(b) schematically illustrates variations in phase modulation amount in a case where the extinction ratio is good. As described above, when the extinction ratio is poor, the phase modulation amount of the phase π increases.

As described above, the delay adjustment unit 5 (FIG. 3) includes the phase modulation unit 52 that modulates the phase of the optical short pulse, the one-pulse delay MZ interferometer 53 that uses the optical short pulse via the phase modulation unit 52 as an input, and the delay amount generation unit 54 that generates the delay amount based on the output of the one-pulse delay MZ interferometer 53. As a result, it is possible to generate optical short pulses with a constant pulse width, chirp, and phase modulation amount, and in particular, it is possible to reduce variations in phase modulation amount.

Note that the minimum configuration of the optical short pulse generator according to the present invention is the configuration of the first embodiment (FIG. 1). That is, the optical short pulse generator 10 includes the first optical intensity modulator 2 that outputs an optical pulse in which the signal intensity of photocarriers output from the light source 1 is modulated in accordance with the magnitude of the first drive signal around the operation bias point α, the delay unit 3 that generates the second drive signal obtained by delaying the first drive signal by a half cycle, and the second optical intensity modulator 4 that outputs the optical short pulse in which the signal intensity of the optical pulse is modulated in accordance with the magnitude of the second drive signal around the operation bias point α. As a result, it is possible to provide an optical short pulse generator capable of generating optical short pulses with minimal variations in pulse width, chirp, and phase modulation amount.

In addition, the simplest method of the optical short pulse generation method according to the present invention performs a first optical intensity modulation step of outputting an optical pulse in which the signal intensity of photocarriers output from the light source is modulated in accordance with the magnitude of the first drive signal around the operation bias point, a delay step of generating the second drive signal obtained by delaying the first drive signal by a half cycle, and a second optical intensity modulation step of outputting the optical short pulse in which the signal intensity of the optical pulse is modulated in accordance with the magnitude of the second drive signal around the operation bias point. As a result, it is possible to provide an optical short pulse generator capable of generating optical short pulses with minimal variations in pulse width, chirp, and phase modulation amount.

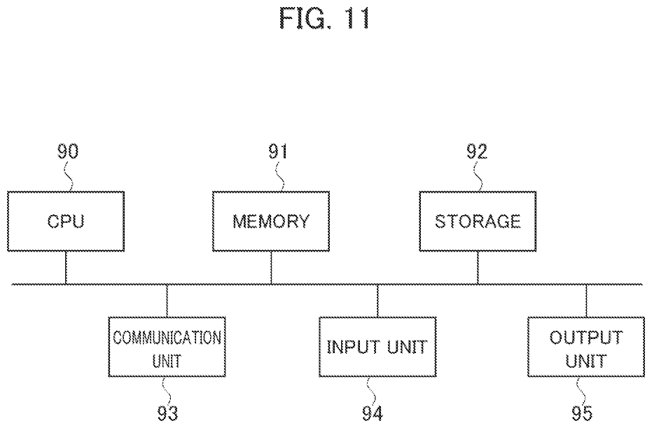

The control unit (not illustrated) of the optical short pulse generator 10 and the delay adjustment unit 5 can be achieved by a general-purpose computer system illustrated in FIG. 11. For example, in a general-purpose computer system including a CPU 90, a memory 91, a storage 92, a communication unit 93, an input unit 94, and an output unit 95, the CPU 90 executing a predetermined program loaded on the memory 91, and each function of the control unit of the optical short pulse generator 10 and the delay adjustment unit 5 is achieved. The predetermined program can be recorded on a computer-readable recording medium such as an HDD, an SSD, a USB memory, a CD-ROM, a DVD-ROM, or an MO, or can be distributed via a network. Note that a GPU may be used instead of the CPU.

Note that, in the above embodiments, the configuration in which the first drive signal and the second drive signal are directly input to the first and second optical intensity modulators 2 and 4 has been described, but the present invention is not limited to this example. The first and second drive signals may be input to the first and second optical intensity modulators 2 and 4 via an amplifier (not illustrated). The same applies between the phase modulation unit 52 and the delay unit 51 illustrated in FIG. 8. In addition, a directional coupler type optical intensity modulator may be used instead of the MZ type optical intensity modulator.

As described above, it is a matter of course that the present invention includes various embodiments and the like not described herein. Accordingly, the technical scope of the present invention is defined only by invention-specifying matters according to the scope of claims appropriate from the above description.

### REFERENCE SIGNS LIST

1 Light source
2 First optical intensity modulator
3, 51 Delay unit
4 Second optical intensity modulator
5 Delay adjustment unit
6 Optical coupler
10, 20, 30, 40, 50 Optical short pulse generator
52 Phase modulation unit
53 One-pulse delay MZ interferometer
54 Delay amount generation unit

1. An optical short pulse generator comprising:
a first optical intensity modulator that outputs an optical pulse in which a signal intensity of photocarriers output from a light source is modulated in accordance with a magnitude of a first drive signal around an operation bias point;
a delay unit that generates a second drive signal obtained by delaying the first drive signal by a half cycle; and
a second optical intensity modulator that outputs an optical short pulse in which a signal intensity of the optical pulse is modulated in accordance with a magnitude of the second drive signal around an operation bias point.

2. The optical short pulse generator according to claim 1, comprising:
a delay adjustment unit that increases or decreases a delay amount by which the delay unit delays the first drive signal.

3. The optical short pulse generator according to claim 2, wherein
the delay adjustment unit
adjusts the delay amount so that a pulse width of the optical short pulse becomes constant.

4. The optical short pulse generator according to claim 3, wherein
the delay adjustment unit
adjusts the delay amount so that the pulse width of the optical short pulse via a dispersion device becomes constant.

5. The optical short pulse generator according to claim 2, wherein
the delay adjustment unit includes
a phase modulator that modulates a phase of the optical short pulse,
a one-pulse delay interferometer that uses the optical short pulse via the phase modulator as an input, and
a delay amount generation unit that generates the delay amount based on an output of the one-pulse delay interferometer.

6. An optical short pulse generation method performing:
a first optical intensity modulation step of outputting an optical pulse in which a signal intensity of photocarriers output from a light source is modulated in accordance with a magnitude of a first drive signal around an operation bias point;
a delay step of generating a second drive signal obtained by delaying the first drive signal by a half cycle; and
a second optical intensity modulation step of outputting an optical short pulse in which a signal intensity of the optical pulse is modulated in accordance with a magnitude of the second drive signal around an operation bias point.

7. The optical short pulse generation method according to claim 6, performing:
a delay adjustment step of increasing or decreasing a delay amount by which the first drive signal is delayed.

8. An non-transitory computer readable storage medium storing an optical short pulse generation program for causing a computer to function as an optical short pulse generator according to claim 1.
